(19) United States
(12) Patent Application Publication
(10) Pub. No.: US 2014/0261944 A1
(43) Pub. Date: Sep. 18, 2014

(54) ENCASING FOR RELEASABLY CONTAINING A DEVICE AND TIRE CONTAINING SUCH ENCASING OR ENCASED DEVICE

(71) Applicant: The Goodyear Tire & Rubber Company, Akron, OH (US)

(72) Inventors: George Jim Papakonstantopoulos, Medina, OH (US); James Gregory Gillick, Akron, OH (US); Bruce Raymond Hahn, Hudson, OH (US)

(73) Assignee: The Goodyear Tire & Rubber Company, Akron, OH (US)

(21) Appl. No.: 13/835,970

(22) Filed: Mar. 15, 2013

(51) Int. Cl. B65D 85/06; B60C 5/14; B60C 19/00

(52) U.S. Cl. CPC B65D 85/06; B60C 19/00; B60C 5/14
USPC 152/510; 206/524.1

(57) ABSTRACT

The present invention relates to an encasing for releasably containing a device and tire containing such encasing or encased device.

### FIELD OF THE INVENTION

The present invention relates to an elastomeric encasing for releasably containing, by holding, a device, particularly for placement of a device in a tire, including, for example, a tire containing such encasing and tire containing such encasing which holds such device. The encasing, or holder, may be comprised of an elastomeric material or a combination of elastomeric material and rigid material. Such encasing, or holder, may be comprised of, for example, a pocketed enclosure, threaded channel, spring loaded bracket or twist and lock mechanism suitable for releasably holding a device. Such device may be, for example, a sensor, or sensor assembly, for sensing and transmitting information generated for or by a tire or any other device which may be used for facilitating an operation of the tire.

### BACKGROUND OF THE INVENTION

Pneumatic rubber tires may sometimes be provided with one or more devices implanted in a portion of the tire. Such device may be, for example, a sensor to sense information relating to, for example, various properties and operating conditions of the tire. The sensed information may be transmitted by such sensor outside of the tire to a receiver. The receiver may be, for example, a control panel of the associated vehicle or an external receiving entity outside of both the tire and automobile. Further, such device may be, for example, a device which may be used for facilitating an operation of the tire.

Historically, a device may be affixed to a tire by imbedding it in, or securely cementing it to, a rubber component of the tire or in a rubber composition which is integral with a component of the tire. Therefore the device may be embedded within a tire component. Such tire component may be, for example, a tire's rubber innerliner layer or a tire's sidewall rubber layer. It is appreciated that such embedded device is difficult to remove from the tire, such as for example, for maintenance or replacement of the device, without damaging the tire itself.

Therefore it is desired to provide a means for placing a device on or in a pneumatic tire in a manner that the device may be removed for maintenance, replacement or other purpose without significantly damaging the tire itself.

In the description of this invention, the term “phr” where used herein, and according to conventional practice, refers to “parts of a respective material per 100 parts by weight of rubber, or elastomer”.

The terms “rubber” and “elastomer” where used herein, may be used interchangeably, unless otherwise prescribed. The terms “rubber composition”, “compounded rubber” and “rubber compound”, where used herein, are used interchangeably to refer to “rubber which has been blended or mixed with various ingredients and materials” and such terms are well known to those having skill in the rubber mixing or rubber compounding art.

The term “carbon black” as used herein means “carbon blacks having properties typically used in the reinforcement of elastomers, particularly sulfur-curable elastomers”, sometimes referred to as rubber reinforcing carbon blacks.

### SUMMARY AND PRACTICE OF THE INVENTION

In accordance with this invention, an elastomeric encasing is provided for releasably holding a device.

In one embodiment, such encasing may be comprised of, for example, an elastomeric material or a combination of elastomeric material and rigid material.

In one embodiment, such encasing, or holder, may be comprised of, for example, a pocketed enclosure, threaded channel, spring loaded bracket or twist and lock mechanism suitable for releasably holding a device.

In one embodiment, such device may be a device to facilitate an operation of the tire such as, for example, a sensor adapted to sense and transmit information generated by the a tire.

In further accordance with this invention, a pneumatic tire is provided having such encasing positioned on a surface of a rubber component of said tire.

In one embodiment, said tire component is a tire rubber innerliner and such encasing is mounted on said tire rubber innerliner within the internal cavity of the tire.

In one embodiment, a pneumatic tire is provided having said encasing positioned on a surface of a tire component to releasably hold and secure a device to the tire.

In one embodiment, for said pneumatic tire, said encasement is comprised of a rubber patch positioned on the surface of a rubber component of the tire where said patch is comprised of an elastomeric material or combination of elastomeric material and rigid material.

In one embodiment, for said tire, such encasing may be comprised of, for example, a pocketed enclosure, threaded channel, spring loaded bracket or twist and lock mechanism suitable for releasably holding the device.

In one embodiment said pneumatic tire is provided with a rubber component comprised of a rubber innerliner layer, where said rubber innerliner layer contains a rubber patch thereon which is integral with said rubber innerliner layer, wherein said rubber patch contains an elastomeric, stretchable rubber cavity to releasably receive and securely hold a rigid device within its elastomeric cavity.

In one embodiment, for said pneumatic tire, said device is a sensor adapted to sense data for at least one physical property of said tire.

In one embodiment, for said pneumatic tire, said device is a device to aid in operation of the tire.

In one embodiment, for said tire, said elastomeric cavity within said patch is slightly smaller in at least one dimension than said device in a manner that upon insertion of the device into said cavity at least a portion of said cavity is necessarily stretched to accommodate receipt of the device within its cavity and the stretched portion of the cavity thereafter relaxed to press against said device and to thereby secure said device within its cavity. It is readily envisioned that the device is releasably contained (secured) within said cavity in a sense that a portion of the cavity may be stretched to enlarge the cavity to thereby accommodate removal of the sensor from the cavity.

In one embodiment, for said tire, said encasement is comprised of an uncured, or partially cured, rubber patch. In this manner then, for the pneumatic tire, as the uncured assembly of rubber components of the tire is cured, the said rubber patch is co-cured therewith and thereby made integral a rubber component of the tire. In one embodiment said tire component is a rubber tire innerliner layer and said cured rubber patch is co-cured with said tire innerliner and thereby integral with the tire innerliner layer.

In one embodiment, for said pneumatic tire, the encasement is of an elastomeric composition and is provided with a configuration comprised of a cavity within said rubber patch with an opening in the cavity to facilitate inserting and releasably containing said device.

In one embodiment, for said pneumatic tire, said cavity of said elastomeric encasement is comprised of a pouch for holding said device and having an elastomeric opening for inserting said device into said pouch and for removing said device from said pouch.

In one embodiment, for said pneumatic tire, said cavity of said elastomeric encasement is comprised of an open cylinder having internal spiral grooves in its wall and said device in a circular shaped device containing external spiral ridges to facilitate inserting said device within and removing said device from said open cylindrical cavity by spirally threading said device inwardly into and spirally threading said device outwardly from said cylindrical cavity.

In one embodiment, said open cylinder contains a rigid cylindrical insert within said open cylinder which contains said internal spiral grooves in its wall adapted to receive the external spiral edges of said device.

In a further embodiment, for said pneumatic tire, said encasement contains said device.

In summary and to present a further description of embodiments of the invention:

In accordance with this invention, an elastomeric encasement is provided which is comprised of a rubber patch containing a cavity to releasably hold a device for use in assisting operation of a pneumatic tire, wherein said cavity is configured with an opening to facilitate inserting said device into and removing said device from said cavity and wherein said elastomeric encasement is comprised of an uncured or partially cured sulfur curable rubber composition.

The elastomeric encasement is further provided wherein said cavity is comprised of a pouch having an elastomeric opening for inserting said device into said pouch and for removing said device from said pouch.

In one embodiment the cavity is enclosed to form said pouch by a base rubber layer upon which the elastomeric encasement is mounted wherein the cavity contains said opening for inserting said device into said cavity and for removing said device from said cavity.

The elastomeric encasement is further provided where at least one dimension of said cavity is less than a corresponding dimension of said device to facilitate providing a secure fitting of said device within said cavity.

The elastomeric encasement is additionally provided wherein the cavity is comprised of an open cylinder wherein its wall contains spirally grooved threads to facilitate inserting said device into and removing said device from said cavity wherein said device has a circular cross-section and contains spirally grooved threads on its periphery which are complementary to (with) said spirally grooved threads of said cylinder and where spirally grooved threads of said cylinder are optionally comprised of a rigid material. Said device is inserted and removed, for example, by engaging the spirally threaded cylinder walls and periphery of the device and twisting the devise to cause it to travel along the spiral threads of the cylinder.

The elastomeric encasement is also provided which contains a cylindrical opening which communicates with said cavity where said cylinder of said opening contains at least two spaced apart grooves (which might be referred to as being slots) recessed in its wall which extend the length of said open cylinder from its opening to the cavity of said elastomeric encasement, where said grooves are adapted to communicate with extended tangs contained on the periphery of said device where said tangs are configured to engage with said grooves to facilitate inserting and removing said device in and from said cavity of said elastomeric encasement through said cylindrical opening and, further, to secure said device within said cavity by twisting said device to cause its tangs contained within said cavity to thereby misalign with said grooves of said cylinder and where said cylinder is optionally comprised of a rigid material.

In one aspect, the elastomeric encasement is provided wherein said cavity is exclusive of an adhesive for holding said devise in said cavity.

In one aspect, the elastomeric encasement is provided wherein said cavity contains a non-permanent adhesive to releasably hold said device within said cavity.

An assembly is provided which is comprised of the elastomeric encasement containing at least a portion of said device within said cavity wherein said device. In one aspect, the device is comprised as a combination of the device and base upon which the device is mounted.

In one aspect, the assembly is provided wherein said device is a rigid device comprised of at least one of a sensor (for sensing data which might be generated by the tire both static data and, also as the tire is being used in service where the data may, if desired, be transmitted to as receiver for receiving the data), energy harvester (energy being generated by motion of the tire as it is being used in service to power the device) and controller (a device for controlling various functions or operational features of the tire).

The invention further contemplates a pneumatic rubber tire containing said elastomeric encasement as a co-cured, integral, component of said tire.

In further accordance with the invention a pneumatic rubber tire is provided containing said assembly as a co-cured, integral, component of a rubber innerliner of said tire.

### BRIEF DESCRIPTION OF THE DRAWINGS

Drawings are presented to further understand the invention. For the Drawings, Figures (FIGs) are provided to depict various configurations of the patch for releasably containing a devise and placement on and within a tire.

FIG. 1 is a partial cross-section of an automobile with front and rear tires with encasements mounted on an inner surface of the tires to facilitate releasably to hold a device such as a sensor to provide signal(s) containing data which is transmitted to a receiver outside of the tires.

FIG. 2 is a partial cross-section of a pneumatic tire with an inner cavity with an inner liner having rubber patches adhered to the tire's innerliner to receive sensors.

FIG. 3A is a pneumatic tire containing two rubber patches disposed in a balanced fashion opposite of each other.

FIG. 3B is a pneumatic tire containing two rubber patches disposed in a balanced fashion opposite of each other.

FIG. 4A is an encasement in a form of a rubber patch which contains a cavity with an opening to insert or remove a device such as, for example, a sensor which may be mounted on a base and/or innerliner.

FIG. 4B is a cross-section of an encasement in a form of a rubber patch taken along section 4B-4B of FIG. 4A.

FIG. 4C is a cross-section of an encasement in a form of a rubber patch taken along section 4B-4B of FIG. 4A mounted on an innerliner.

FIG. 4D is a cross-section of an encasement in a form of a rubber patch taken along section 4B-4B of FIG. 4A mounted on a rubber backing.

FIG. 4E is a cross-section of a rubber patch taken along section 4B-4B of FIG. 4A which is mounted on a rubber backing which is further mounted on an innerliner.

FIG. 5A illustrates preparation of a rubber patch.

FIG. 5B further illustrates preparation of a rubber patch.

FIG. 5C illustrates an assembled rubber patch.

FIG. 5D additionally illustrates an assembled rubber patch.

FIG. 5E illustrates completion of a rubber patch.

FIG. 5F illustrates a rubber patch with a device being inserted into the rubber patch.

FIG. 5G illustrates a completed rubber patch containing an inserted device.

FIG. 6A is a top view of a rubber patch containing a cavity for receiving a device.

FIG. 6B is a cross-section of a rubber patch with a spirally threaded cavity for receiving a device.

FIG. 6C a top view of a rubber patch containing a cavity for receiving a device.

FIG. 6D is a cross-section view of a rubber patch containing a spirally threaded cavity for receiving a device.

FIG. 7A illustrates an exploded view of the preparation sequence of a rubber patch.

FIG. 7B is a perspective view of a product of a prepared rubber patch.

FIG. 7C is an exploded view of removing a molding plug contained in a rubber patch.

FIG. 7D is an exploded view of a rubber patch with plug shown in FIG. 7C being removed and insertion of a device in a cylindrical cavity contained in a patch.

FIG. 7E is an exploded view of a rubber patch with a device inserted in a cylindrical cavity contained in the patch.

FIG. 8A is a top view of a rubber patch on a rubber base or innerliner.

FIG. 8B is a cross-sectional view of a rubber patch with a cavity.

FIG. 8C is a cross-section of a rubber patch on a rubber base or innerliner.

FIG. 8D is a cross-section of a patch on a rubber base or innerliner.

FIG. 9A is an exploded view of a preparation sequence for a rubber patch.

FIG. 9B illustrates an exploded view of a preparation sequence for a rubber patch.

FIG. 9C illustrates an exploded view of a preparation of a rubber patch.

FIG. 9D shows an exploded view of inserting a device in a cylindrical cavity of a rubber patch.

FIG. 9E is an exploded view of a device inserted in a cylindrical cavity of a rubber patch.

FIG. 10A is a top view of an example of a variation of an encasement in a rubber patch.

FIG. 10B is a cross-section of an example of a variation of an encasement in a rubber patch.

FIG. 10C is a top view of an example of an encasement in a rubber patch.

FIG. 10D is a cross-section of an example of a variation of an encasement in a rubber patch.

FIG. 11A illustrates preparation of a rubber patch.

FIG. 11B further illustrates preparation of a rubber patch.

FIG. 11C illustrates an assembled rubber patch containing a mold piece on a rubber base layer.

FIG. 11D illustrates an assembled rubber patch with a mold piece removed.

FIG. 11E illustrates an assembled rubber patch with an insertion of a device

FIG. 11F illustrates an assembled rubber patch containing an inserted device with a signal being emitted from the device.

### IN THE DRAWINGS

In the Drawings, FIG. 1 is presented to show a cross section of an automobile (1) with front and rear tires (2) with encasements (11) mounted on an inner surface of the tires (e.g. innerliner of the tire) to facilitate releasably holding a device to aid in operating the tire. For example such device may be a sensor to provide signal(s) containing data which is transmitted to a receiver (4) outside of the tires (2) to, for example, a location within the automobile (1).

FIG. 2 is presented to show a partial cross section of a pneumatic tire (2) composed of a tread (5), spaced apart bead portions (7) and connecting sidewalls (8). For the inner cavity of the pneumatic tire (2) a rubber innerliner (9) is provided having rubber patches (10) and (10′) integrally adhered to and overlaying a portion of the innerliner (9) in the crown region and the sidewall region, respectively, of the tire (2). The rubber patches (10) and (10′) are depicted with elastomeric (rubber) cavities (11) and (11′), respectively configured slightly smaller than a rigid sensor (not shown) in order to receive and releasably contain and secure the rigid sensor by elastomeric pressure of the elastomer of the overlay cavities of the patches (11) and (11′) against the sensor when positioned within the cavities (10) and (10′).

FIGS. 3A and 3B are presented to show a pneumatic tire containing two rubber patches disposed in a balanced fashion, or configuration, opposite of each other on the tire's innerliner in the crown region or on a sidewall portion of the tire.

In particular, FIG. 3A illustrates a perspective view of a partial cross section of the pneumatic tire (2) containing two rubber patches (10) and (12) integrally adhered to the tire innerliner (9) with each patch individually positioned in the crown region of the tire (2) on opposite sides of the tire (2) from each other in a weight balancing configuration. For this described configuration, one patch overlay (10) contains a cavity (11) for containing a device such as, for example, in a form of a sensor (not shown). The other patch overlay (12) is used to provide a weight balanced distribution of the patch overlays (10) and (12) and does not contain a cavity.

FIG. 3B is similar to FIG. 3A except that the rubber patches (10) and (12) are positioned in the sidewall region of the tire (2) on its innerliner (9) in a similarly weight balanced configuration with one patch (10) containing a cavity (11) for containing a device for example in a form of a sensor (not shown).

FIGS. 4 A, B, C, D and E are presented to show an encasement in a form of a rubber patch which contains a cavity (e.g. an open or enclosed cavity) with an opening to insert or remove a device (e.g. a sensor) for which the encasement may be mounted on a base and/or tire innerliner.

In particular, FIG. 4A illustrates an overhead view of a combination of rubber patch (10) with an internal cavity (14) and longitudinal opening (13) for gaining access to the internal cavity (14) with the patch (10) being mounted on and adhered to a base or tire innerliner layer (15). FIGS. 4B, 4C, 4D and 4E are views taken along sectioned 4B of FIG. 4A.

FIG. 4B illustrates a cross section of the patch (10) as a rubber housing with its open cavity (14), for releasably containing a device (not shown) and opening (13) for insertion and removal of the device.

FIG. 4C illustrates the patch (10) mounted on and integrally adhered to a tire rubber innerliner layer (15) in a manner to complete a closure of the cavity (14) with its opening (13) for insertion and removal of a device (not shown).

FIG. 4D illustrates the patch (10) as a rubber housing mounted on and adhered to a base rubber layer (16) as a rubber backing in a manner to complete a closure of the cavity (14) with its opening (13) for insertion and removal of a device (not shown).

FIG. 4E illustrates the patch (10) as a rubber housing mounted on and adhered to a base layer (16) as a rubber backing in a manner to complete a closure of a cavity with its opening (13) and the assembly thereof further mounted on and its base rubber backing layer (16) and adhered to a tire rubber innerliner layer (15) where a device (17) is depicted as being inserted through opening (13) into and thereafter releasably contained and held in the cavity.

FIGS. 5 A, B and C (FIGS. 5A, 5B and 5C) are presented to illustrate a preparation of a rubber patch (20).

FIG. 5A shows a base layer or rubber innerliner rubber layer (18) onto which mold halves (19A) and (19B) are positioned.

FIG. 5B illustrates rubber pieces (20A) and (20B) bring placed over mold pieces (19A) and (19B), respectively.

FIG. 5C illustrates rubber pieces (20A) and (20B) being brought together with projections of mold pieces (19) and (19A) therebetween being exposed and extending outwardly with the rubber pieces (20A) and (20B) being cured with the rubber base or tire innerliner layer (18) to form an integral portion of the tire.

FIG's 5D, 5E, 5F and 5G are presented to illustrate removal of the mold pieces and insertion of a device.

FIG. 5D illustrates removal of mold piece (19A) through an opening created by the mold pieces to form a cavity within the cured rubber patch (20) integrally cured to and with the rubber base or tire innerliner layer (18).

FIG. 5E illustrates removal of mold piece (19B) through an opening created by the mold pieces to form a cavity within the cured rubber patch (20) integrally cured to and with the rubber base or tire innerliner layer (18).

FIG. 5F illustrates an insertion of a base portion (23A) of a device assembly (22), with the device (23B) contained on its base portion (23A), into an opening of a cavity (21) within the patch (29) contained on and integral with the rubber backing or tire inner rubber layer (18).

FIG. 5G illustrates the device (22) mounted on with its base portion mounted within the cavity releasably contained within the cavity of the patch (20) mounted on and integral adhered to the rubber backing or tire innerliner rubber layer (18). FIG. 5G also shows a high frequency signal being emitted from the device in a sense of the device being a sensor sending tire data to a remote receiver (not shown).

FIGS. 6A, 6B, 6C and 6D are presented to show a rubber patch, and its preparation, containing a spirally threaded cavity (e.g. a spirally threaded channel) for receiving a device.

FIG. 6A illustrates an overhead view of a patch assembly (24) composed of a patch (26) mounted on a rubber backing or tire innerliner rubber layer (25). The patch (26) contains a plug (27) to form a spirally threaded cavity in the patch where the plug (27) contains a spirally threaded wall (28) for molding a complementary spirally threaded wall in the cavity of the patch (26).

FIG. 6B illustrates a vertical cross sectional view of a of the patch assembly (24) with the patch (26) mounted on a rubber base (25) together with the plug (27) with its spirally threaded wall (28) which forms a complementary spirally threaded wall (29) molded in the cavity of the patch (26).

FIG. 6C illustrates an overhead view of the patch assembly (24) with the patch (26) and its supporting rubber base (25) from which the plug (27 in FIG. 6B) has been removed to leave the spirally threaded wall (29) within cylindrical cavity of the patch (26).

FIG. 6D illustrates a vertical cross sectional view of the patch assembly (24) with its patch (26) mounted on its supporting rubber base (25) the cylindrical cavity of the patch having its spirally threaded wall (29) for which a threaded device may be inserted (threaded) into or withdrawn from the device.

FIGS. 7A and 7B are presented to show an exploded view of the preparation sequence of FIGS. 6A through 6D.

FIG. 7A illustrates an assembly (24) with placement of the patch (26) with its smooth walled cylindrical cavity onto a rubber base or tire innerliner rubber layer (25) and with a plug, or insert (27) with a shaft containing a spirally threaded surface (28) to be inserted into the smooth walled cavity of the rubber patch (26).

FIG. 7B illustrates an assembly (24) comprised of the patch (26) on a rubber base or tire innerliner layer (25) and cured to form an integral assembly (24) containing the plug (27) which thereby forms a complementary spirally threaded surface (not shown) on the wall of the cylindrical cavity in the patch (26).

FIGS. 7C, 7D and 7E are presented to show an exploded view of removing a molding plug and inserting a device (e.g. sensor) in cylindrical cavity contained in a patch on a rubber base of tire innerliner rubber layer.

FIG. 7C illustrates an assembly (24) with placement of the patch (26) on a rubber base or tire innerliner rubber layer (25) as shown in previous FIG. 7B now with its plug (27) with its spirally threaded shaft (28) being removed to reveal the complementary spirally threaded wall (29) of the cylindrical cavity formed by the spirally threaded shaft (28) on the plug (27).

FIG. 7D illustrates an assembly (24) of the patch (26) mounted on a rubber base (25) with a device (30) which includes a spirally threaded shaft (31) positioned to be spirally threaded (inserted) into the of the patch (26) with its complementary spirally treaded wall (29) for which a threaded device may be inserted (threaded) into or removed from the cavity.

FIG. 7E illustrates the assembly (24) of the patch (26) mounted on its rubber base (25) with the device being threaded into the spirally threaded cavity of the patch (26) with a portion of the device (30) being exposed and depicted as radiating a high frequency signal to transmit tire data to a remote receiver (not shown).

FIGS. 8A, 8B, 8C and 8D are presented to show preparation of a cavity in a patch on a rubber base or tire innerliner rubber layer which contains a slotted opening for the cavity to thereby create a twist-and-lock operation of mechanism for inserting (and removing) a device from a patch cavity.

FIG. 8A illustrates al top view of an assembly (32) of a rubber patch (34) mounted on a rubber base or tire innerliner rubber layer (33) which contains a molding plug (35B in FIG. 8B) with its surface (38) shown by a dashed line and having two opposing tangs (37) protruding from a small shaft (36) of the plug to form slots, or grooves (40 shown in FIG. 8C) in the opening to the cavity of the patch (34).

FIG. 8B illustrates a vertical cross sectional view of the patch (34) mounted on a rubber base (33) with the plug assembly (35) composed of a mold plug (35B) and threaded plug cap (35A). The surface (38) of the plug (35A) is to define the cavity (38) within the patch (34) and the tangs (37) protruding from the shaft (36) are to define slots, or grooves (40 shown in FIG. 8C).

FIG. 8C illustrates a top view of the assembly (32) after partially curing, composed of the patch (34) and its rubber base (33) with the molding plug (not shown) removed to reveal the opening to the cylindrical cavity (41) of the rubber patch (34) with the molded two opposing slots, or grooves (40).

FIG. 8D illustrates a vertical cross sectional view of the patch (34) with rubber base (33), internal cavity (41), slots (40) and small opening (39) through which the device may be inserted into or withdrawn from the internal cavity (41) of the patch (34).

FIGS. 9A, 9B and 9C are presented to illustrate an exploded view of the preparation sequence of FIGS. 8A through 8D.

FIG. 9A illustrates an assembly (32) with its patch (34) and rubber base (33) with placement of the patch (34) with its smooth walled cylindrical cavity onto the rubber base or tire innerliner rubber layer (33) and with the molding plug (35B) containing the tangs (37) on either side of a shaft (36) of the plug (35B) and surface (38) to define a cavity within the patch (34) together with a spirally threaded outer extension of the plug (35B) to receive the internally threaded plug cap (35A).

FIG. 9B illustrates the assembly (32) comprised of the patch (34) on the rubber base (33) where the cap of the plug assembly (35) can be seen and which caps the aforesaid plug (35A) which is beneath the plug cap and therefore not seen in this FIG. 9B.

FIG. 9C illustrates the assembly (32) of the rubber patch (34) and rubber base (33) and mold assembly (35) with the with the plug, or insert, (not shown) removed as well as its outer plug cap (35A) with its threaded shaft (35B) also being removed to reveal the small opening (39) to the cavity (41) with the two opposing slots (40).

FIGS. 9D and 9E are presented to show an exploded view of inserting of a device (e.g. sensor) in the cylindrical cavity with its slotted opening contained in a patch on a rubber base of tire innerliner rubber layer.

FIG. 9D illustrates the assembly (32) of the rubber patch (32) on its rubber base (33) with its small opening (39) to its internal cavity (41) for which the small opening (39) contains opposing slots (40). A device assembly (42) is shown as a device (43) containing an upper portion (43) and lower portion (44). The upper portion (43) contains an indented slot (46) and the lower portion contains a shaft with two opposing tangs (45) to engage slots (40).

FIG. 9E illustrates the assembly (32) with the rubber patch (34) mounted on a rubber base (33) with the device assembly (42) inserted into the cavity of the patch to cause its protruding tangs to engage the slots of the patch and thereby extend entirely through the small opening into the cavity (41) of the patch and the indented slot (46) in the upper portion (43) of the device assembly (42) used to turn the device assembly 90 degrees to thereby twist and removably locking the device assembly (42) to the cavity (41) and thereby to the patch (34), by its protruding tangs contained within in the cavity (41) of the patch (34).

FIGS. 10A and 10B are presented to show an example of a variation of the encasement presented in FIGS. 4A, 4B, 4C and 4D, with FIG. 10C presented to illustrate the encasement with mold pieces contained in the encasement. The encasement is a two-piece (or two-sectioned) encasement in a form of a rubber patch which contains a cavity (e.g. which can be an open or enclosed cavity) for releasably holding a device and having an opening to insert or remove a device (e.g. a sensor) for which the encasement may be mounted on a rubber base and/or a tire innerliner rubber layer.

In particular, FIG. 10A (FIG. 10A) illustrates a an overhead view of rubber patch (49) comprised of a an encasement (48) with overlapping shells (48B) and 48A) which communicate with the peripheral side of the encasement (48) where said overlapping shells are comprised of an inner first shell (48A) and a second outer shell (48B) to define a an internal cavity (50) between said shells for releasably holding a device (e.g. holding a sensor) wherein the second outer shell (48B) is an overlapping relationship with the first inner shell (48A) to define an opening (50) between the overlapping portion of the shells (48A) and (48B) which extends to the internal cavity (52) to permit insertion and removal of a device into and out from the internal cavity (52) of the encasement (48). The encasement (48) is mounted on a base (51) composed of a base rubber layer or tire innerliner rubber layer to effect a closure of the internal cavity (52) beneath the shells (48A) and (48B).

FIG. 10B is a side elevational view taken along section lines 10B-10B of FIG. 10A.

FIG. 10B shows a cross section of the rubber patch (49) as a two piece rubber housing with its internal cavity (52), for releasably containing a device (not shown), defined by the aforesaid first inner shell (48B) and overlapping outer second shell (48A) with the opening (50) therebetween which extends through the overlapping portion of shells (48A) and (48B) into the internal cavity (52) for permitting insertion and removal of a device (e.g. sensor). A rubber base rubber layer (51), in a form of a rubber base or tire innerliner rubber layer, is shown to effect a closure of the internal cavity (52) beneath said shells (48A) and (48B).

FIG. 10C shows a cross section of the rubber patch (49) which contains mold pieces (48A) and (48B) contained in the encasement cavity and which are to be removed upon its completion (e.g. by partially curing the rubber patch, or encasement).

FIGS. 11A, 11B and 11C are presented to illustrate a preparation of a rubber patch (or encasement with its cavity) (49).

FIG. 11A shows a rubber base layer or rubber innerliner rubber layer (51) onto which rubber patch halves (49A) and (49B) are assembled.

FIG. 11B shows rubber patch halves (49A) and (49B) assembled on the rubber base layer (51) together with mold pieces (48A) and 48B) which are used to establish the cavity within the encasement, or rubber patch. The assembly is identified as item (47)

FIG. 11C shows the assembly (47) positioned on rubber base layer (or rubber innerliner layer) to be cured with (therefore to become integral with) the tire in a suitable mold at an elevated temperature.

FIGS. 11D, 11E, and 11F are presented to illustrate removal of the mold pieces and insertion of a device.

FIG. 11D shows removal of the mold (49) in a form of mold insert pieces (48A) and 49(B) which are referred to in the drawing as “Remove insert halves” through the opening (50) created by the mold pieces to form a cavity within the cured rubber patch, or encasement. The rubber patch, or encasement (47) is partially cured to make the encasement (47) integral with the rubber base or tire innerliner layer (51).

FIG. 11E shows an insertion of a device (53) through opening (50) into the cavity within the rubber patch, or encasement.

FIG. 11F illustrates the device (53) being held by the rubber patch, or encasement mounted on and integrally adhered to the rubber backing or tire innerliner rubber layer (51).

FIG. 11F further shows a high frequency signal being emitted from the device in a sense of the device being a sensor sending tire data to a remote receiver (not shown).

While certain representative embodiments and details have been shown for the purpose of illustrating the invention, it will be apparent to those skilled in this art that various changes and modifications may be made therein without departing from the spirit or scope of the invention.

What is claimed is:

1. An elastomeric encasement comprised of a rubber patch containing a cavity to releasably hold a device for use in assisting operation of a pneumatic tire, wherein said cavity is configured with an opening to facilitate inserting said device into and removing said device from said cavity and wherein said elastomeric encasement is comprised of an uncured or partially cured sulfur curable rubber composition.

2. The elastomeric encasement of claim 1 wherein said cavity is comprised of a pouch having an elastomeric opening for inserting said device into said pouch and for removing said device from said pouch.

3. The elastomeric encasement of claim 2 wherein cavity is enclosed to form said pouch by a base rubber layer upon which the elastomeric encasement is mounted wherein the cavity contains said opening for inserting said device into said cavity and for removing said device from said cavity.

4. The elastomeric encasement of claim 1 where at least one dimension of said cavity is less than a corresponding dimension of said device to facilitate providing a secure fitting of said device within said cavity.

5. The elastomeric encasement of claim 1 wherein the cavity is comprised of an open cylinder wherein its wall contains spirally grooved threads to facilitate inserting said device into and removing said device from said cavity wherein said device has a circular cross-section and contains spirally grooved threads on its periphery which are complementary to said spirally grooved threads of said cylinder and where spirally grooved threads of said cylinder are optionally comprised of a rigid material.

6. The elastomeric encasement of claim 1 which contains a cylindrical opening which communicates with said cavity where said cylinder of said opening contains at least two spaced apart grooves recessed in its wall which extend the length of said open cylinder from its opening to the cavity of said elastomeric encasement, where said grooves are adapted to communicate with extended tangs contained on the periphery of said device where said tangs are configured to engage with said grooves to facilitate inserting and removing said device in and from said cavity of said elastomeric encasement through said cylindrical opening and, further, to secure said device within said cavity by twisting said device to cause its tangs contained within said cavity to thereby misalign with said grooves of said cylinder and where said cylinder is optionally comprised of a rigid material.

7. The elastomeric encasement of claim 1 wherein said cavity is exclusive of an adhesive for holding said devise in said cavity.

8. The elastomeric encasement of claim 1 wherein said cavity contains a non-permanent adhesive to releasably hold said device within said cavity.

9. An assembly comprised of said elastomeric encasement of claim 1 containing at least a portion of said device within said cavity wherein said device is optionally comprised of a combination of the device and base upon which the device is mounted.

10. The assembly of claim 9 where said device is a rigid device comprised of at least one of a sensor, energy harvester and controller.

11. A pneumatic rubber tire containing said elastomeric encasement of claim 1 as a co-cured, integral, component of said tire.

12. A pneumatic rubber tire containing said elastomeric encasement of claim 1 as a co-cured, integral, component of a rubber innerliner of said tire.

13. A pneumatic rubber tire containing said elastomeric encasement of claim 2 as a co-cured, integral, component of a rubber innerliner of said tire.

14. A pneumatic rubber tire containing said elastomeric encasement of claim 3 as a co-cured, integral, component of a rubber innerliner of said tire.

15. A pneumatic rubber tire containing said elastomeric encasement of claim 4 as a co-cured, integral, component of a rubber innerliner of said tire.

16. A pneumatic rubber tire containing said elastomeric encasement of claim 5 as a co-cured, integral, component of a rubber innerliner of said tire.

17. A pneumatic rubber tire containing said elastomeric encasement of claim 6 as a co-cured, integral, component of a rubber innerliner of said tire.

18. A pneumatic rubber tire containing said elastomeric encasement of claim 7 as a co-cured, integral, component of a rubber innerliner of said tire.

19. A pneumatic rubber tire containing said assembly of claim 8 as a co-cured, integral, component of a rubber innerliner of said tire.

20. The pneumatic rubber tire of claim 12 where said device is a rigid device comprised of at least one of a sensor, energy harvester and controller.
